(19) United States
(12) Patent Application Publication
(10) Pub. No.: US 2006/0203274 A1
(43) Pub. Date: Sep. 14, 2006

(54) Document processing apparatus, method of control of such apparatus and storage medium storing document processing program

(75) Inventor: Akira Hirose, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/224,061

(22) Filed: Sep. 13, 2005

(30) Foreign Application Priority Data
Mar. 9, 2005 (JP) 2005-065452

(51) Int. Cl. G06F 3/12

(52) U.S. Cl. 358/1.13

(57) ABSTRACT

A document processing apparatus receives a command to create a data file, creates a predetermined format data file of a document to be processed, and stores the file into a storage. After receiving the command to create a data file, a screen is presented that prompts input of attribute information to be retained in association with a file of the document, before the file is created and stored into the storage.

The entire disclosure of Japanese Patent Application No. 2005-065452 filed on Mar. 9, 2005 including specification, claims, drawings and abstract is incorporated herein by reference in its entirety.

This application claims foreign priority under 35 USC 119 based on the foregoing Japanese patent application. The priority claim is being made concurrently with the filing of this application.

### BACKGROUND

1. Technical Field

The present invention relates to a document processing apparatus which creates a predetermined format data file based on an electronic document or the like.

2. Related Art

In related art computers, when a command is issued to print a document, a printer driver displays a screen for setting parameters involved in printing, allowing the user to specify print parameters on the screen. The print parameters include, for example but not by way of limitation, paper setting, the number of documents to print, printer selection, and pages to print. These print parameters, once set, are used when the printing process is executed.

Meanwhile, related art software creates a data file from a document, utilizing a setting screen provided by the printer driver. For example but not by way of limitation, Adobe's Acrobat® which creates a Portable Document Format (PDF) file when receiving a command to print a document, displays a user interface for setting various parameters as the setting screen for the printer driver. In accordance with the parameters specified on the setting screen, Acrobat creates and outputs the PDF file.

A technique for creating a data file from a document by utilizing the printer driver, extracting keywords from the document, and associating and storing the created data file with the keywords into a database is disclosed in Japanese Published Unexamined Patent Application No. Hei 8-147446.

In the above-mentioned related art technique disclosed in Japanese Published Unexamined Patent Application No. Hei 8-147446, however, a keywords is extracted from the document by software processing. Consequently, attribute information, such as the keyword and other attributes to be associated with the data file, is not always selected as intended by the user.

On the other hand, according to another related art technique, a user may create a keyword to a document in advance, and the user then registers the document using the keyword. Also, a user may create a keyword in association with the created data file after creating the data file. However, by using the foregoing related art techniques, the usability is decreased when the user forgets the settings or when the user performs operation of the settings separately.

### SUMMARY

The present invention has been made in view of the above circumstances and therefore provides a document processing apparatus that can enhance usability. However, other objects, or some or none of the stated objects, may be achieved without departing from the scope of the invention.

According to an exemplary, non-limiting embodiment, there is provided a document processing apparatus which receives a command to create a data file, creates a predetermined format data file of a document to be processed, and stores the file into a storage, wherein, after receiving the command to create a data file, a screen that is presented prompts input of attribute information to be retained in association with a file of the document, before the file is created and stored into the storage.

### BRIEF DESCRIPTION OF THE DRAWINGS

These and other features, aspects, and advantages of the present invention will become better understood with reference to the following description and accompanying drawings, which should not be read to limit the invention in any way, in which:

FIG. 1 is a block diagram showing an example of a construction of a document processing apparatus according to an exemplary, non-limiting embodiment and a non-limiting example of connecting the apparatus to a server via a network;

FIG. 2 shows a non-limiting example of setting of attribute information to be entered;

FIG. 3 is a functional block diagram showing a non-limiting example of the document processing apparatus according to an exemplary, non-limiting embodiment;

FIG. 4 shows an example of a parameter setting screen that is presented by the document processing apparatus according to an exemplary, non-limiting embodiment;

FIG. 5 shows a non-limiting example of an attribute setting screen that is presented by the document processing apparatus according to an exemplary, non-limiting embodiment;

FIG. 6 shows a non-limiting example of first information for setting attribute information to be entered;

FIG. 7 shows a non-limiting example of second information for setting attribute information to be entered; and

FIG. 8 shows another non-limiting example of holding attribute information.

### DETAILED DESCRIPTION

An exemplary, non-limiting embodiment will now be described with reference to the drawings. A system for processing a document so as to generate a data file is provided. The system may include an apparatus as shown in the drawings and discussed below, and may also perform the process discussed below. Additionally, the process of the system may be performed in a computer-readable medium or data carrier configured to store a set of instructions, in conjunction with the apparatus.

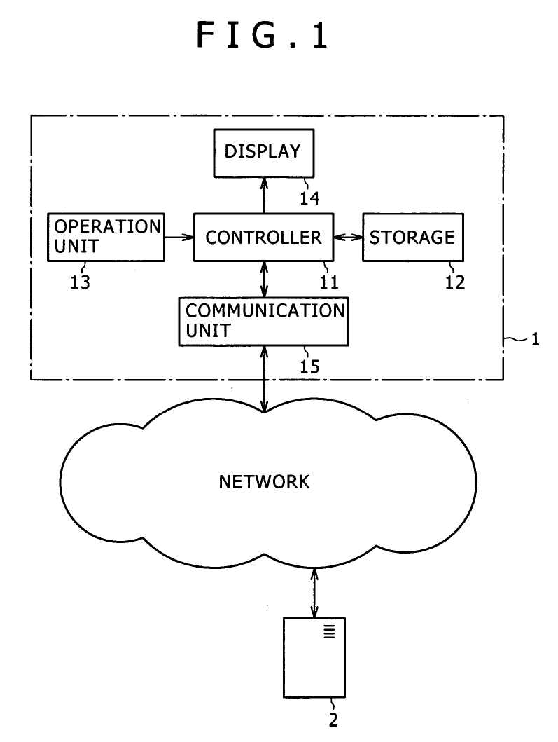

Referring to FIG. 1, a document processing apparatus according to a non-limiting, exemplary embodiment is described. The document processing apparatus 1 includes a controller 11, a storage 12, an operation unit 13, a display 14, and a communication unit 15, as shown in FIG. 1. This document processing apparatus 1 is coupled to a server 2 via a network. In this exemplary, non-limiting embodiment, a data file created by the document processing apparatus 1 is managed such that it is uploaded to the server 2 and stored into any of multiple storage destinations set up on the server 2.

The controller 11 of the document processing apparatus 1 is a CPU or the like and operates under the control of a program stored in the storage 12. The controller 11 creates a data file of a document to be processed when the controller 11 receives a command. For example but not by way of limitation, the command is a print command. At this time, the controller 11 executes a process to accept processing parameters involved in creating the data file and to accept input of attribute information to be retained, associated with the document.

The storage 12 is, for example but not by way of limitation, a memory, a hard disk, or the like (i.e., a computer-readable medium or data carrier), and retains the program (i.e., set of instructions) that is executed by the controller 11. This storage 12 also operates as a working memory for the controller 11.

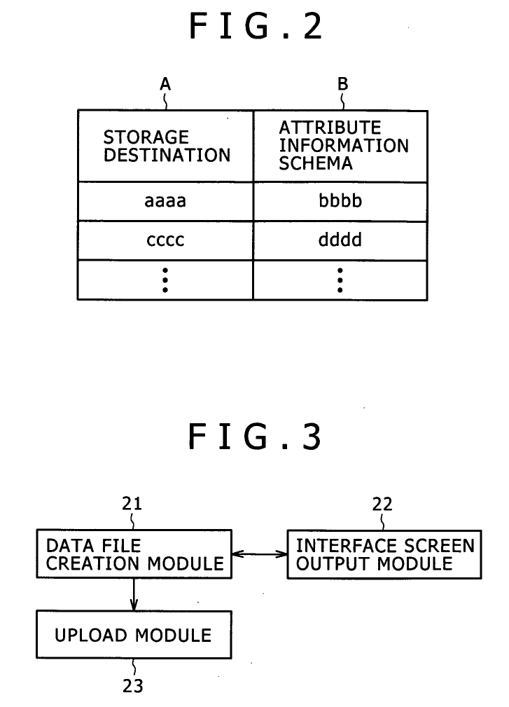

The storage 12 retains information (A) and information (B) as shown in FIG. 2. Information (A) shows a storage destination of the data file created based on the document. Information (B) shows an attribute information schema for specifying default attribute information. Information (A) is related information (B) Here, a basic non-limiting example is shown; however, practically, a storage destination may also be denoted by a Uniform Resource Locator (URL) or the like, which may be separately associated with a display name that is presented on an interface screen. A detailed non-limiting example will be disclosed later.

Additionally, the user interfaces with the system via a user interface that includes the operation unit 13 and the display unit 14.

The operation unit 13 includes a keyboard, a mouse, etc., but is not limited thereto. The operation unit 13 accepts and conveys data input and a command from the user to the controller 11.

The display 14 is, for example but not by way of limitation, a display or the like, and displays information in accordance with an instruction issued from the controller 11. Various structures may be used for the display 14, including for example but not by way of limitation, a visual display such a video display screen, or an interactive screen (e.g., touch or eye-gaze response) may be provided. As explained in greater detail below, the initial information displayed by the display 14 includes default information, which can be modified based on an input from the user, so as to generate information that is described in greater detail below.

The communication unit 15 is a network interface or the like. It uploads a data file to, for example but not by way of limitation, the server 2 via the network in accordance with an instruction issued from the controller 11. This communication unit 15 receives data incoming via the network and passes the received data to the controller 11.

The server 2 is, for example but not by way of limitation, a WebDAV server or the like operating as a server that can accept uploaded data files. This server 2 receives a data file and attribute information to be associated with the file and stores the received data file associated with the attribute information to a specified storage destination in a server storage (not shown).

In response to a command to read a data file, this server 2 reads the specified data file from the server storage (not shown) and delivers the file via the network. The server storage is not the same as the storage 12.

Next, operation of the controller 11 will be described. The program that is executed by the controller 11 functionally includes a data file creation module 21, an interface screen output module 22, and an upload module 23, as is shown in FIG. 3. In this exemplary, non-limiting embodiment, by executing this program by the controller 11, the functionality of the document processing apparatus is realized.

The data file creation module 21, upon receiving a print command as a command to create a data file during the execution of an application program, creates a data file of a document upon which the running application program operates. When receiving the print command, the data file creation module 21 instructs (i.e., generates an instruction to) the interface screen output module 22 to present an interface screen. Then, the data file creation module 21 receives information specified by the user from the interface screen output module 22 and creates the data file. A non-limited detailed example of the created data file is disclosed further below.

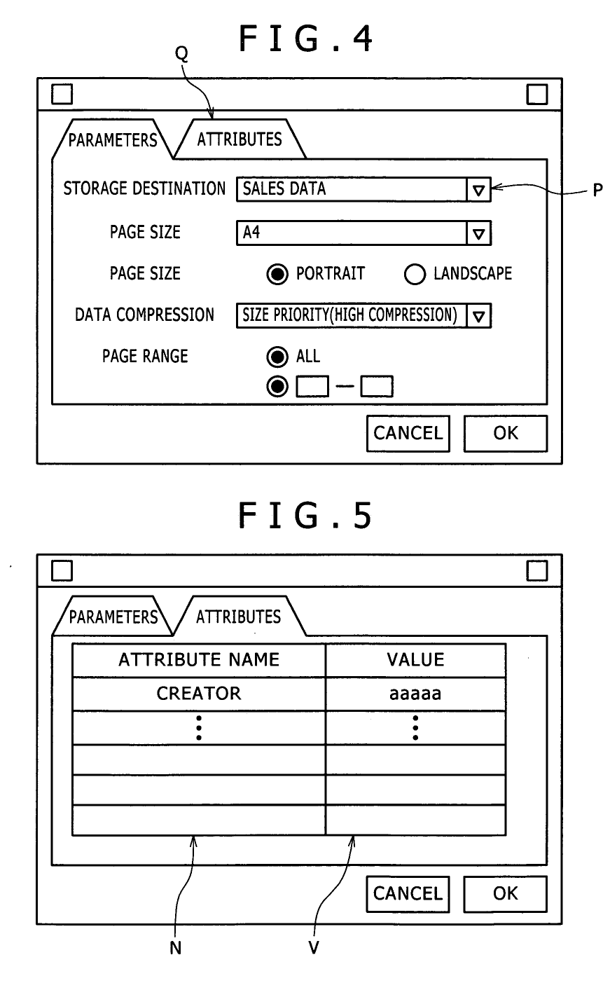

In accordance with an instruction given from the data file creation module 21, the interface screen output module 22 presents an interface screen. As this interface screen, a screen such as for example but not by way of limitation a parameter setting screen provided by a printer driver is presented, as is shown in FIG. 4. Specifically, this interface screen includes items to be specified, such as a range of pages of the document to be output as the data file, as shown in FIG. 4.

Also, the screen includes an interface (P) allowing the user to select a data file storage destination. Here, a list of options of storage destinations preconfigured will be presented for selection. This interface (P) is embodied in a pull-down menu in the example of FIG. 4. This interface screen corresponds to a parameter setting screen involved in the present invention.

Furthermore, from this interface screen, attribute information can be entered. In the example of FIG. 4, by clicking a tab (Q), a screen for entering attribute information is presented (FIG. 5). This screen corresponds to an attribute setting screen.

The interface screen output module 22 retrieves the information of a data file storage destination and information specifying the default attribute information. The information specifying the default attribute information is stored in the storage 12 and is retrieved based on the information of the data file storage destination. When displaying the screen for entering attribute information, the interface screen output module 22 presents the attribute information specified by the retrieved information as the default.

This screen for entering attribute information allows the user to enter an attribute name (N) and its value (V), which are mutually associated, as shown in FIG. 5. In addition to default entry fields, fields are provided in which arbitrary values can be entered. This screen allows the user to enter an arbitrary attribute name and its value in these fields, so that the entered attribute and value can be associated with the data file.

Thus, the data file creation module 21 creates a data file in accordance with the parameters (page range, paper setting, etc.) specified on the interface screen presented by the interface screen output module 22. This data file creation process is substantially similar to the related art method for PDF creation. Therefore, further explanation is omitted.

One feature of this embodiment is that the data file creation module 21 outputs the data file and the attribute information (including but not limited to the names and values of attributes) in association with the file, entered through the screen for entering attribute information, to the upload module 23. Also, the data file creation module 21 outputs the storage destination information selected on the interface screen to the upload module 23.

When the upload module 23 receives the created data file, the attribute information to be associated with the file, and the storage destination information from the data file creation module 21, the upload module 23 requests the server 2 to associate and store the data file with the attribute information into the storage destination. The server is identified by the storage destination information.

This upload module 23 operates as a WebDAV client, if the server 2 is a WebDAV server. It requests the server 2 to store the data file into the storage destination specified as a WebDAV collection and to store the attribute information (property) in association with the data file. This capability of associating a data file with its attribute information and storing it is one feature of the WebDAV server. If the server on which data files are retained is not provided with the function of associating a data file with its attribute information and storing it, a database to retain a data file identifier and related attribute information is created on the server 2. The upload module 23 requests the server 2 to store the data file and to store the data file identifier and its attribute information into the database.

As above, according to the exemplary non-limiting embodiment, after receiving a command to print a document, the screen (FIG. 5) is presented prompting input of attribute information to be retained in association with the data file, before the data file of the document is created and stored on the server 2 serving as a storage.

In this exemplary, non-limiting embodiment, the attribute setting screen, which is the screen prompting input of attribute information, and the parameter setting screen that accepts user-specified parameters involved in creating the data file are displayed in such a manner that both screens can be switched from one to another.

As a result, attribute information such as a keyword for search to be associated with a data file can be set as intended by the user. During the process of data file creation, a step of inputting attribute information is included in a series of operations of data file creation. For example but not by way of limitation, this step may be performed in synchronization with accepting user-specified parameters involved in creating the data file. Therefore, the above-described related art problem associated with the user forgetting to perform setup and having to do the setup operation separately is avoided. Usability can be thus enhanced.

While the parameter setting screen for parameters involved in data file creation and the attribute setting screen for entering attribute information are displayed, and can be switched from one to another, according to this exemplary, non-limiting embodiment, these screens may alternatively be displayed together in a single screen. The parameter setting screen and the attribute information screen may be displayed in sequence, i.e., after displaying one screen, displaying another.

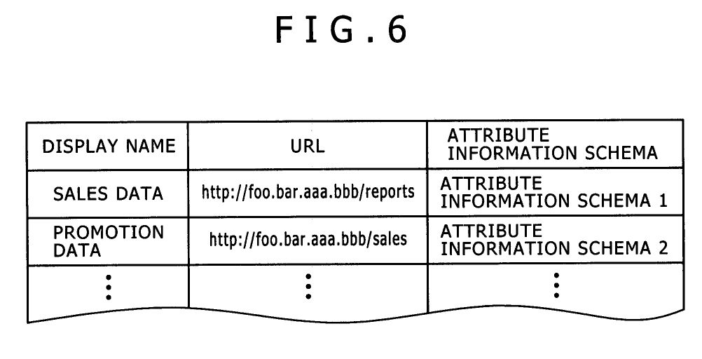

Next, operation of the document processing apparatus 1 will be described. In the following description, it is assumed that information identifying a storage destination and the identifier of related attribute information schema are previously stored in a record in the storage 12, as is shown in FIG. 6. In the example of FIG. 6, each record further includes the name for identifying each storage destination. In the example of FIG. 6, different attribute information schemata are associated with a storage destination “sales data” and a storage destination “promotion data.”

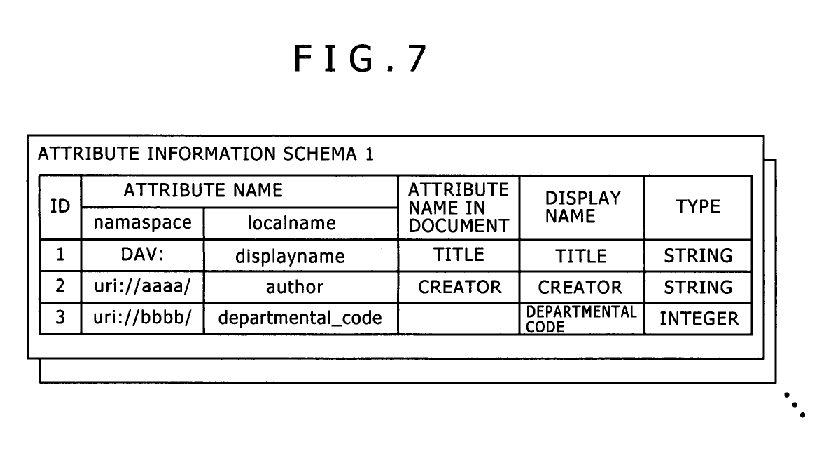

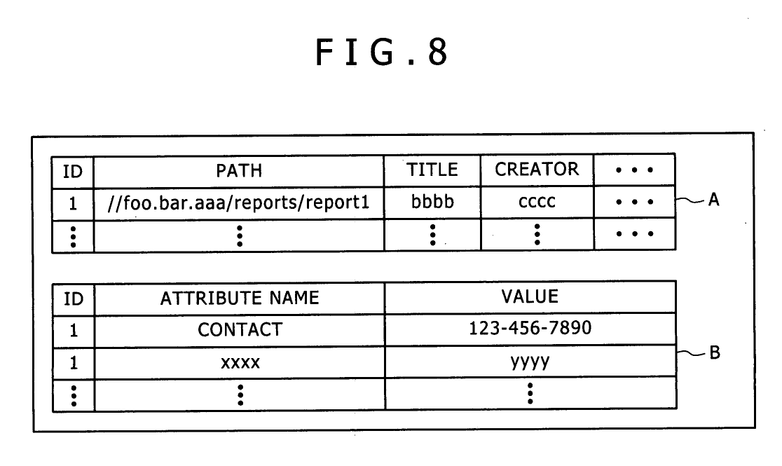

Furthermore, the storage 12 includes a list of default attribute information schema records. Each of the records is composed of related items: an identifier (ID), an attribute name (which may be specified by combination of a name space and a local name), an attribute name in document, a display name, and its data type, as shown in FIG. 7.

The user operates the document processing apparatus 1 and has a document to be processed displayed, using, for example but not by way of limitation, a spreadsheet application, and issues a print command. Then, the spreadsheet application displays the parameter setting screen (FIG. 4) for parameters involved in data file creation. It is assumed that a printer driver that carries out data file creation has been set as a default printer. However, the present invention is not limited thereto.

The document processing apparatus 1 displays a list of the identifiers of storage destinations stored in the storage 12 on this screen, allowing the user to select a storage destination. Here, it is assumed that the user selected a storage destination “sales data.” When the user clicks the attributes tab, the document processing apparatus 1 displays the attribute setting screen (FIG. 5).

The document processing apparatus 1 retrieves an attribute information schema “attribute information schema 1” associated with the selected “sales data” storage destination from the storage 12. Referring to the attribute information schema 1, it displays default attribute information on the attribute setting screen.

Here, in particular, the apparatus retrieves and shows display name “title,” display name “creator,” two string-type data items, display name “departmental_code,” and integer-type data, as default attribute information, on the attribute setting screen, as shown in FIG. 7.

On this attribute setting screen, in this non-limiting example, the user has entered, “Performance-1Q” for the title, “Taro Yamada” for the creator, and “1234” for the departmental_code. When the user clicks the “OK” button, the data file creation process starts. More specifically, the spreadsheet application program sends instructions to draw characters and figures to the program for data file creation in substantially the same way as it would output data to a printer (generally, via an operating system).

The document processing apparatus 1 creates the data file in accordance with the draw instructions. At this time, the apparatus creates the data file, according to the parameters specified on the parameter setting screen for the printer driver. If it is possible to embed attribute information into the data file (the data file format allows for attribute information setting within it), the apparatus includes attribute information within the data file being created. Because it is here assumed that attribute names in document have been specified to be set within the data file, in the above example, “Performance-1Q” and “Taro Yamada” for “title” and “creator” as the attribute names in document are set.

If it is impossible to set some attribute information, for example but not by way of limitation, attribute name “departmental_code,” because of data file format restrictions, the attribute name in document should not be set for “departmental_code” in the attribute information schema as illustrated in FIG. 7. Then, in the data file creation process, the document processing apparatus 1 will not include attribute information for which the attribute name in the document is not set in the schema. In other words, the schema should be prepared such that it is distinguishable between attribute information to be included in the data file and attribute information not to be included in the data file. During the data file creation, the controller 11 will include in the data file the attribute information that is to be included in the data file.

The thus-created data file is temporarily stored in the storage 12. Next, the document processing apparatus 1 accesses the server 2 having the selected storage destination. According to the shown example, the apparatus sends the data file to the server 2 (assumed to be a WebDAV server, but not limited thereto) identified by storage destination “http://foo.bar.aaa.bbb/reports” associated with “sales data,” using a WebDAV PUT method.

The apparatus requests the server to store the entered attribute information in association with the data file, using a WebDAV PROPATCH method. Here, the apparatus sends the attribute information described, for example but not by way of limitation, in the following format.

```
PROPPATCH /reports/Performance-1Q.dat
HOST: foo.bar.aaa.bbb
Content-Type: text/xml;charset=“utf-8”
Content-Length:xxxx
<?xml version=1.0” encoding=“utf-8” ?>
<D:propertyupdate xmlns:D=“DAV:”
xmlns:ns1=“uri://aaaa/” xmlns:ns2=“uri://bbbb/”>
  <D:set>
    <D:prop>
      <D:displayname>Performance-1Q </D:displayname>
        <ns1:author>Taro Yamada</ns1:author>
<ns2:departmental_code>1234</ns2:departmental_code>
    </D:prop>
  </D:set>
</D:propertyupdate>
```

This attribute information is described such that each item of attribute information can be distinguished by a string corresponding to an “attribute name” in the attribute information scheme. Here, attribute information is expressed by using XML.

Upon completion of sending the data file, the document processing apparatus 1 may erase the data file which has been stored temporarily in the storage 12.

While, in the above-described operation example, a data type is set for each item of attribute information in the attribute information schema, the schema may include additional fields for specifying a range of values and a string pattern that can be entered. An initial value of attribute information may be defined by specifying the initial value itself or specifying a method for generating the initial value. Moreover, the schema may include an auxiliary field indicating mandatory or omissible input of each item of attribute information.

According to these specifications, the document processing apparatus 1 checks, for example but not by way of limitation, whether an entered value falls within the set range or whether mandatory attribute information has been entered. If the set conditions are not satisfied, the apparatus may notify or prompt the user of an error before creating the data file or before sending the data file. Furthermore, it is not always necessary to specify a data type; for example but not by way of limitation, it can be prescribed that all attributes be specified in strings.

If associating a data file with attribute information is performed separately, using a database instead of WebDAV, this database may be prepared as, for example but not by way of limitation, a relational database. That is, the database may be prepared to hold a first table (A) storing records in which information identifying a data file (its ID and the path for the file storage location) is associated with predefined attribute information and a second table (B) storing records in which information identifying a data file (the ID from the first table) is associated with attribute information specified (e.g., arbitrarily) by the user.

The attribute information specified arbitrarily by the user is information entered by the user, but not defined as default attribute information in the attribute information schema (for example but not by way of limitation, a telephone number “123-456-7890” as “contact” information which is not included in the attribute information schema 1 shown in FIG. 7). The predefined attribute information is information defined as default attribute information in the attribute information schema.

In this case, the document processing apparatus 1 sends an SQL command to the database server to cause the server to set the attribute information.

As described above, according to an exemplary, non-limiting embodiment, there is provided a document processing apparatus which receives a command to create a data file, creates a predetermined format data file of a document to be processed, and stores the file into a storage, wherein, after receiving the command to create a data file, a screen that is presented prompts input of attribute information to be retained in association with a file of the document, before the file is created and stored into the storage.

The present invention provides a document processing apparatus which receives a command to create a data file, creates a predetermined format data file of a document to be processed, and stores the file into a storage. After receiving the command to create a data file, a screen is presented that prompts input of attribute information to be retained in association with a file of the document, before the file is created and stored into the storage.

According to an aspect of the present invention, the present invention also provides a document processing apparatus which receives a command to create a data file, creates a predetermined format data file of a document to be processed, and stores the file into a storage, wherein the command to create a data file is received, a parameter setting screen is displayed that accepts user-specified parameters involved in creating the file, and an attribute setting screen is displayed that accepts user-specified attribute information to be retained in association with the file created.

In the foregoing, the parameter setting screen and the attribute setting screen may be displayable, switched from one to another.

According to another aspect of the present invention, the present invention provides a method of control of a document processing apparatus which receives a command to create a data file, creates a predetermined format data file of a document to be processed, and stores the file into a storage. The method includes, after receiving the command to create a data file, presenting a screen that prompts input of attribute information to be retained in association with a file of the document, before the file is created and stored into the storage.

Another aspect of the present invention, the invention provides a computer-readable medium storing a instructions in the form of a document processing program which receives a command to create a data file, creates a predetermined format data file of a document to be processed, and stores the file into a storage. The program causes the document processing apparatus to, after receiving the command to create a data file, present a screen that prompts input of attribute information to be retained in association with a file of the document, before the file is created and stored into the storage.

The present invention includes a system for processing a document to generate a data file, including a controller that generates an output instruction in response to a command, and a user interface that, in response to the output instruction, displays default information selected from a plurality of default information records, and receives an input from the user to generate storage destination information and attribute information. In response to the input, the controller generates the data file by associating the storage destination information with the attribute information. The system also includes a storage that stores the data file generated at the controller.

Also, a method of control of a document processing apparatus to generate a data file is also provided, including, in response to a data file generation command, displaying a selected one of a plurality of default attribute records, receiving storage information and attribute information from a user, and associating the storage information with the attribute information to generate the data file, wherein the file is stored in a storage.

Additionally, a computer-readable medium including instructions for processing a document to generate a data file is provided. The instructions include, in response to a data file generation command, displaying a selected one of a plurality of default attribute records, receiving storage information and attribute information from a user, and associating the storage information with the attribute information to generate the data file, wherein the file is stored in a storage.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A system for processing a document to generate a data file, comprising:
a controller that generates an output instruction in response to a command;
a user interface that, in response to the output instruction, displays default information selected from a plurality of default information records, and receives an input from said user to generate storage destination information and attribute information, wherein in response to said input, said controller generates said data file by associating said storage destination information with said attribute information; and
a storage that stores said data file generated at said controller.

2. The system of claim 1, wherein said default information comprises default attribute information, said default parameter information is displayed on a parameter display and said default attribute information is displayed on an attribute display, and said input comprises a user-specified parameter and user-specified attribute information.

3. The system of claim 2, wherein said parameter display and said attribute display are configured to be viewed sequentially or simultaneously.

4. The system of claim 1, said controller comprising:
a data file creation module that receives said command and generates said instruction, and creates said data file based on said input from said user;
an interface screen output module that, in response to said instruction from said data file creation module, retrieves said default information and provides said default information to said user interface, and receives said input from said user; and
an upload module that requests a server to store said data file and said attribute information in association with an identifier of said data file.

5. The system of claim 1, said user interface comprising a display that displays said default information and said input from said user, and an operation unit that receives said input from said user in response to said default information displayed on said display.

6. The system of claim 1, wherein said data file is stored in accordance with a specification by a server based on an association between said data file and said attribute information.

7. The system of claim 1, wherein said server is a WebDAV server.

8. The system of claim 1, wherein a relational database is configured to perform said associating.

9. The system of claim 1, wherein when said input from said user does not include mandatory information, said display outputs an error notification to said user.

10. A method of control of a document processing apparatus to generate a data file, comprising:
in response to a data file generation command, displaying a selected one of a plurality of default attribute records;
receiving storage information and attribute information from a user; and
associating said storage information with said attribute information to generate said data file, wherein said file is stored in a storage.

11. A computer-readable medium including instructions for processing a document to generate a data file, said instructions comprising:
in response to a data file generation command, displaying a selected one of a plurality of default attribute records;
receiving storage information and attribute information from a user; and
associating said storage information with said attribute information to generate said data file, wherein said file is stored in a storage.
